(19) United States
(12) Patent Application Publication
(10) Pub. No.: US 2019/0111496 A1
(43) Pub. Date: Apr. 18, 2019

(54) CUTTING TOOL TIP, CUTTING TOOL, AND METHOD FOR PRODUCING CUT WORKPIECE USING SAME

(71) Applicant: KYOCERA CORPORATION, Kyoto-shi, Kyoto (JP)

(72) Inventor: Katsura HAYASHI, Moriyama-shi, Shiga (JP)

(21) Appl. No.: 16/089,377

(22) PCT Filed: Mar. 27, 2017
(86) PCT No.: PCT/JP2017/012405

§ 371 Date: Sep. 28, 2018

(30) Foreign Application Priority Data
Mar. 30, 2016 (JP) 2016-068788

(51) Int. Cl. B23B 27/14; B23C 5/16; B23B 27/20

(52) U.S. Cl. CPC B23B 27/148; B23B 2222/28; B23B 27/20; B23C 5/16

(57) ABSTRACT

A cutting tool tip may include a first region and a second region. The second region may differ from the first region in material and may include a cutting edge in at least a part of a ridge line part of surfaces adjacent to each other. A boundary surface between the first region and the second region may include a curved surface portion projecting from a side of the second region toward a side of the first region.

### CROSS-REFERENCE TO RELATED APPLICATIONS

This application is a national stage entry according to 35 U.S.C. 371 of PCT Application No. PCT/JP2017/012405 filed on Mar. 27, 2017, which claims priority to Japanese Application No. 2016-068788 filed on Mar. 30, 2016, which are entirely incorporated herein by reference.

### TECHNICAL FIELD

The present disclosure relates to a cutting tool tip used in cutting processes, such as a milling process or a turning process.

### BACKGROUND

A cutting tool tip (hereinafter referred to simply as “a tip”) may be used in a cutting process of a workpiece, such as metal. For example, in Japanese Unexamined Patent Publication No. 10-511432 (Patent Document 1) describes a tip. The tip illustrated in FIG. 2E of Patent Document 1 may include a first region and a second region which are different from each other in material. The second region may include a cutting edge. The first region and the second region may be metallurgically bonded together.

In the tip described in Patent Document 1, because the first region and the second region may have a flat plate shape, a boundary surface between the first region and the second region becomes a flat surface. A load is therefore likely to advance in a direction along the flat surface by a force applied during the cutting process, and the second region may separate from the first region.

Aspects of the disclosure have been made in view of the above problem, and aim at providing a tip having two regions well joined together.

### SUMMARY

A cutting tool tip may include a first region and a second region. The second region may differ from the first region in material and may include a cutting edge in at least a part of a ridge line part of surfaces adjacent to each other. A boundary surface between the first region and the second region may include a curved surface portion being projected from a side of the second region toward a side of the first region.

### BRIEF DESCRIPTION OF THE DRAWINGS

FIG. 1 is a perspective view illustrating a tip in a first non-limiting embodiment;

FIG. 2 is a top view of the tip illustrated in FIG. 1;

FIG. 3 is a side view as viewed from A1 direction in the tip illustrated in FIG. 2;

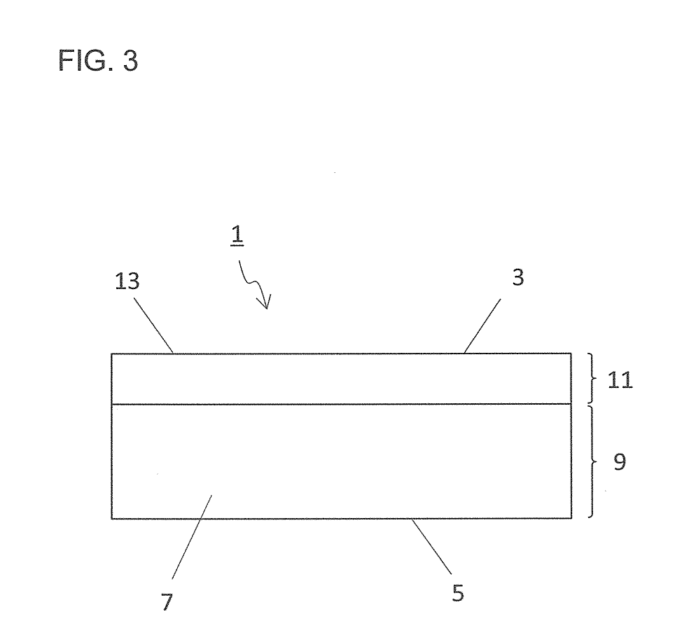

FIG. 4 is a sectional view taken along line B1-B1 in the tip illustrated in FIG. 2;

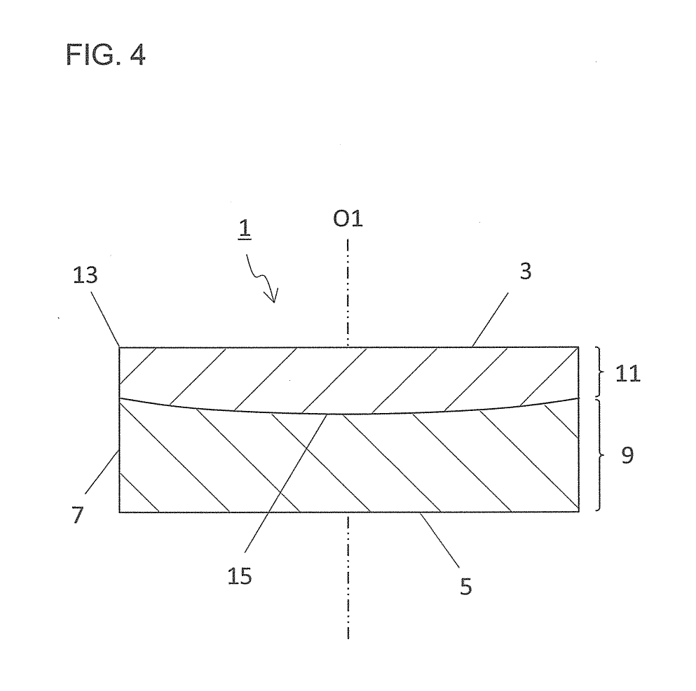

FIG. 5 is a sectional view taken along line B2-B2 in the tip illustrated in FIG. 2;

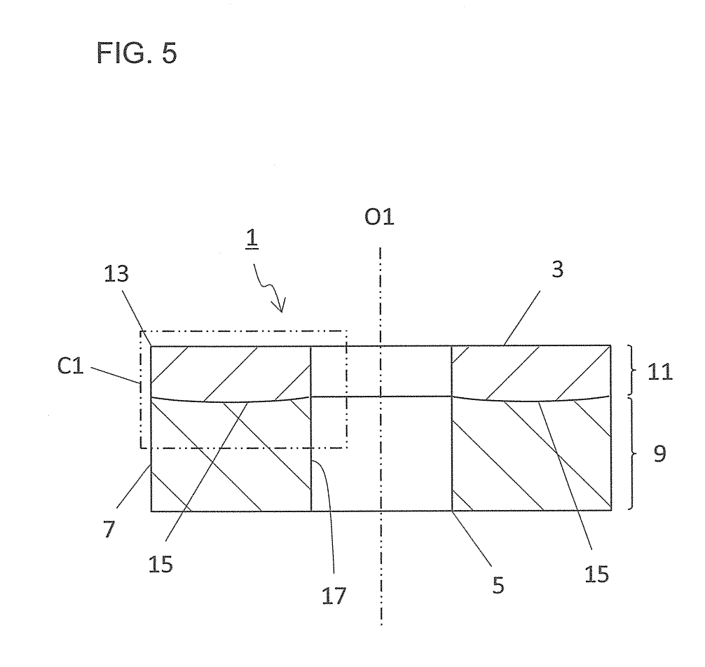

FIG. 6 is an enlarged view in a region C1 illustrated in FIG. 5;

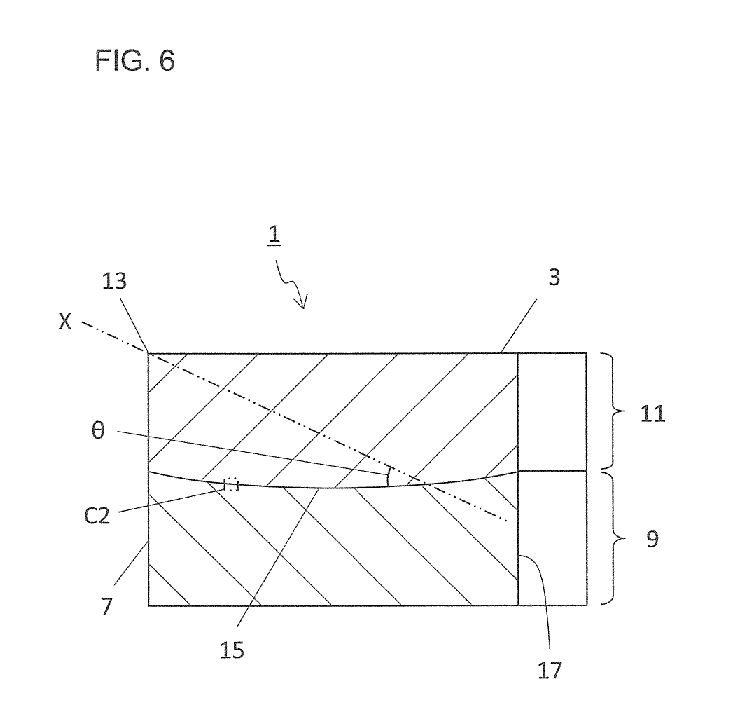

FIG. 7 is a perspective view of a first modification of the tip illustrated in FIG. 1;

FIG. 8 is a perspective view of a second modification of the tip illustrated in FIG. 1;

FIG. 9 is a sectional view taken along line B3-B3 in the tip illustrated in FIG. 8;

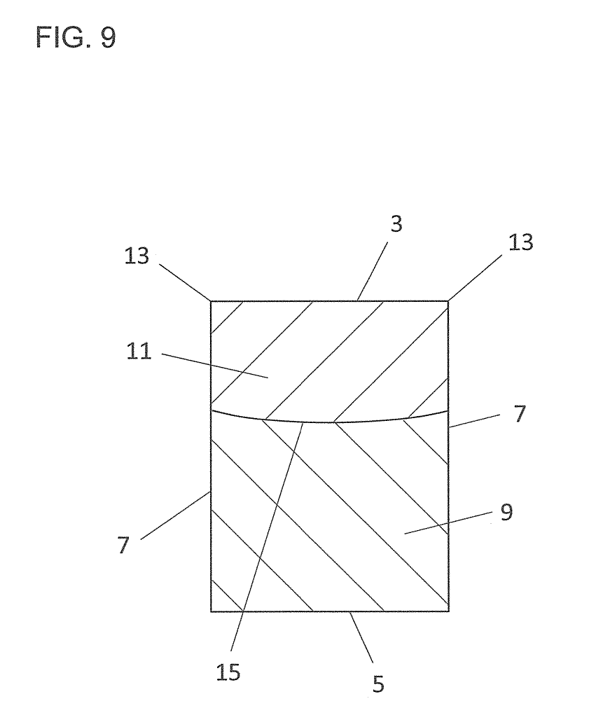

FIG. 10 is a perspective view of a third modification of the tip illustrated in FIG. 1;

FIG. 11 is an enlarged view in a region C2 illustrated in FIG. 6;

FIG. 12 is a perspective view illustrating a tip in a second non-limiting embodiment;

FIG. 13 is a side view as viewed from A2 direction in the tip illustrated in FIG. 12;

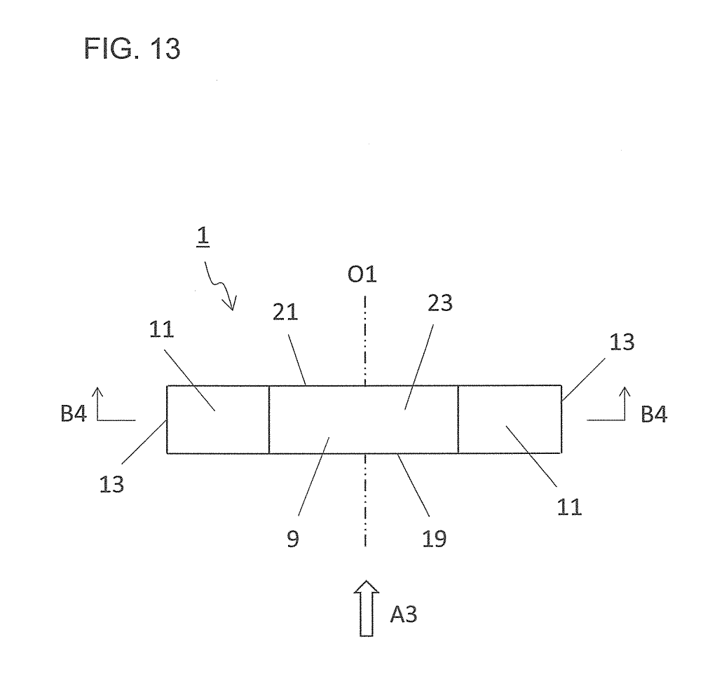

FIG. 14 is a side view as viewed from A3 direction in the tip illustrated in FIG. 13;

FIG. 15 is a sectional view taken along line B4-B4 in the tip illustrated in FIG. 13;

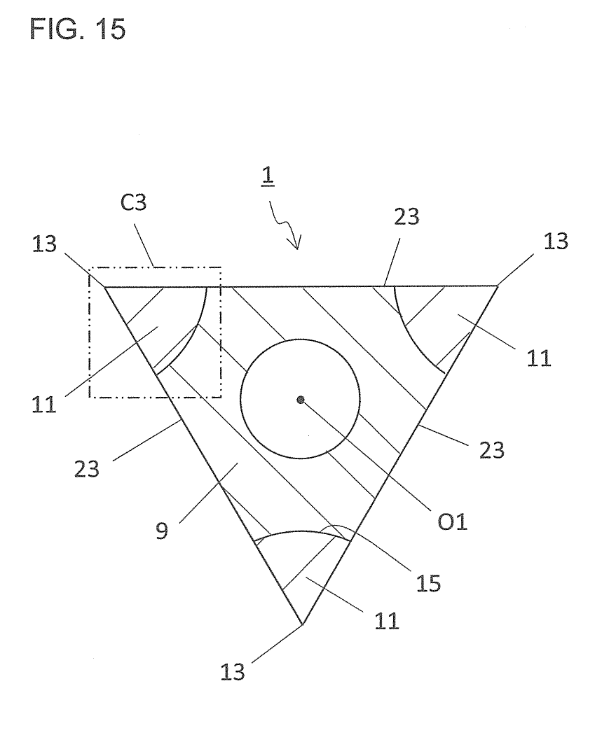

FIG. 16 is an enlarged view in a region C3 illustrated in FIG. 15;

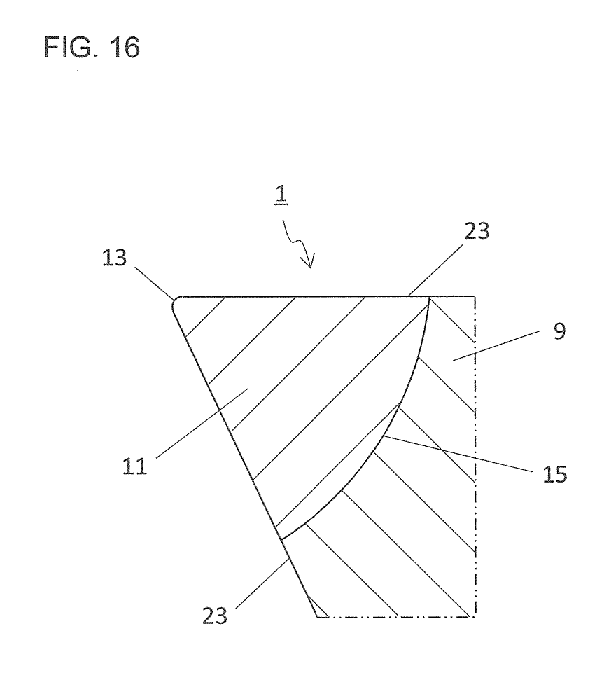

FIG. 17 is a sectional view taken along line B5-B5 in the tip illustrated in FIG. 14;

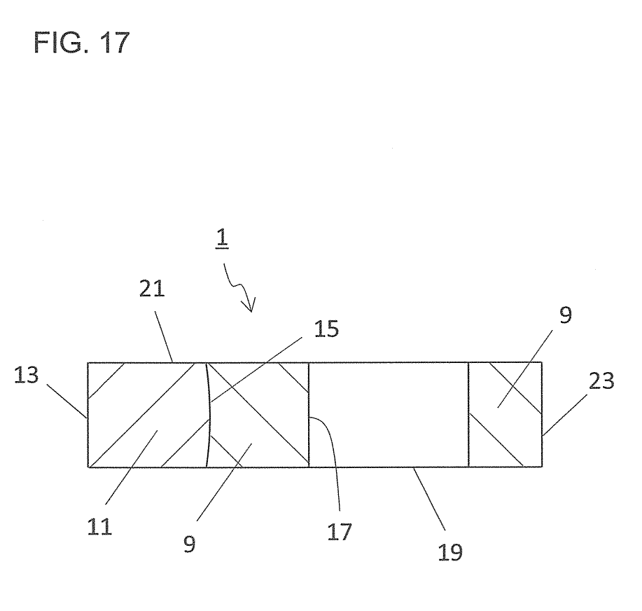

FIG. 18 is a perspective view illustrating a cutting tool in a non-limiting aspect of the disclosure;

FIG. 19 is a schematic diagram illustrating a step in a method of manufacturing a machined product in a non-limiting aspect of the disclosure;

FIG. 20 is a schematic diagram illustrating a step in a method of manufacturing a machined product in a non-limiting aspect of the disclosure; and

FIG. 21 is a schematic diagram illustrating a step in a method of manufacturing a machined product in a non-limiting aspect of the disclosure.

### DETAILED DESCRIPTION

<Tip>

Tips 1 in a plurality of embodiments are respectively described in detail below with reference to the drawings. For the sake of description, the drawings referred to in the following illustrate, in a simplified form, only main members necessary for describing the embodiments. The tips disclosed below are therefore capable of including any arbitrary structural member not illustrated in the drawings referred to. Sizes of the members in each of the drawings do not faithfully represent sizes of actual structural members and size ratios of these members.

Firstly, the tip 1 of the first non-limiting embodiment is described with reference to the drawings. The tip 1 of a non-limiting aspect of the disclosure is usable, for example, in an external turning process that is one of turning processes.

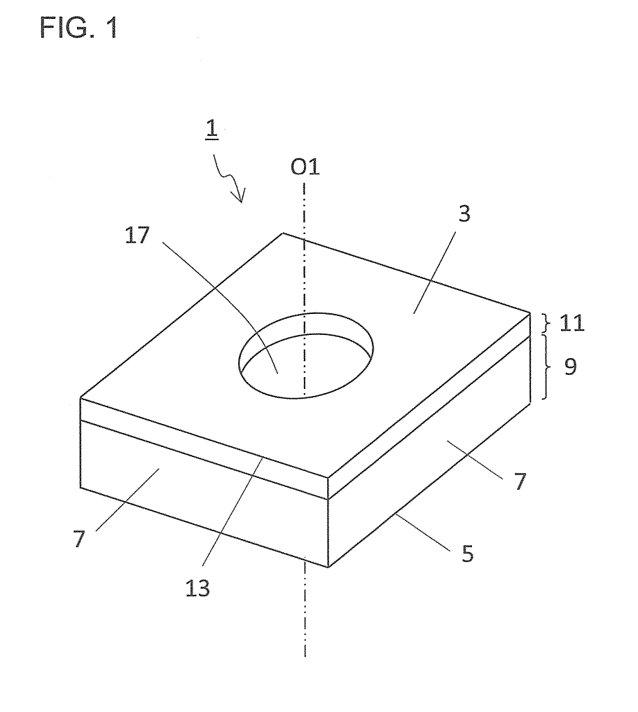

The tip 1 of a non-limiting aspect of the disclosure includes a first surface, a second surface, and a third surface as illustrated in FIG. 1.

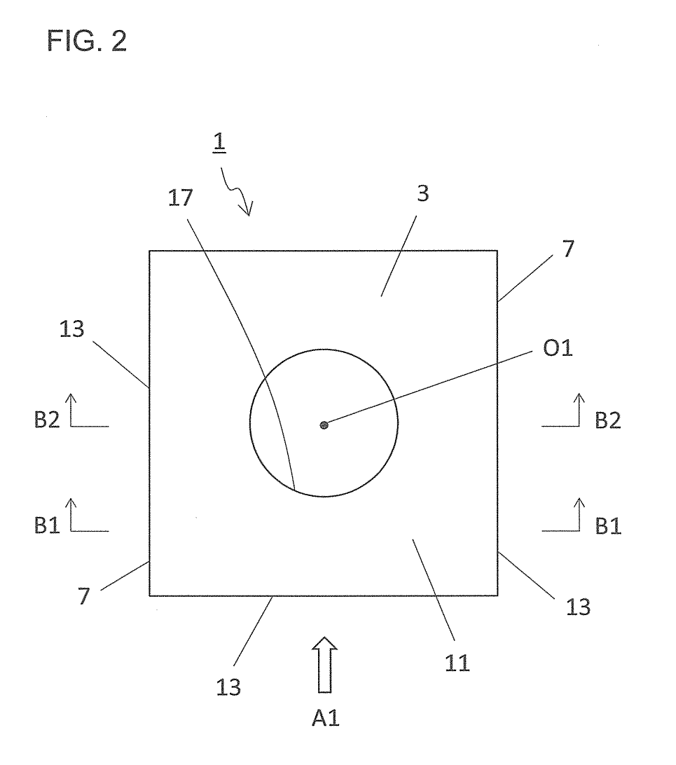

Hereinafter, for the sake of convenience, the first surface, the second surface, and the third surface are respectively referred to as “an upper surface 3,” “a lower surface 5,” and “a side surface 7” in conformity to FIG. 1. The upper surface 3 has an approximately polygonal shape and includes a plurality of corner parts and a plurality of side parts as illustrated in FIG. 2. The upper surface 3 has a quadrangular shape and includes four corner parts and four side parts in a non-limiting aspect of the disclosure.

The corner parts in a non-limiting aspect of the disclosure are not limited to strict corners, but may have a slightly rounded shape. The side parts in the upper surface 3 are not respectively limited to strict straight line shaped ones, but may include a region having a curvilinear shape.

The lower surface 5 is a surface which is located on a side opposite to the upper surface 3, and which functions as a seating surface with respect to a pocket when attaching the tip 1 of a non-limiting aspect of the disclosure to a holder. Similarly to the upper surface 3, the lower surface 5 in a non-limiting aspect of the disclosure has an approximately polygonal shape, specifically, an approximately quadrangular shape. The lower surface 5 in a non-limiting aspect of the disclosure has the same shape as the upper surface 3. The upper surface 3 is overlapped with the lower surface 5 in a top view. Alternatively, the tip 1 may be configured so that the lower surface 5 is somewhat smaller than the upper surface 3. In this case, the lower surface 5 is made in a similar shape to the upper surface 3.

The side surface 7 is a surface adjacent to the upper surface 3. As illustrated in FIG. 1, the side surface 7 in a non-limiting aspect of the disclosure is located between the upper surface 3 and the lower surface 5, and connects to each of the upper surface 3 and the lower surface 5. Because each of the upper surface 3 and the lower surface 5 has the quadrangular shape, the side surface 7 is composed of four surface regions. Because the upper surface 3 and the lower surface 5 have the same shape, the side surface 7 in the tip 1 illustrated in FIG. 1 is orthogonal to the upper surface 3 and the lower surface 5.

Although no particular limit is imposed on a size of the tip 1, for example, a maximum value of a width in a top view (in a front view of the upper surface 3) is settable to approximately 5-20 mm in a non-limiting aspect of the disclosure. A maximum value of a thickness between the upper surface 3 and the lower surface 5 is 3-10 mm.

The tip 1 of a non-limiting aspect of the disclosure is composed of a first region 9 and a second region 11 adjacent to each other, and has a quadrangular plate shape as a whole. Specifically, each of the first region 9 and the second region 11 in a non-limiting aspect of the disclosure has a quadrangular plate shape, and second region 11 is overlaid on the first region 9. Accordingly, the tip 1 has a quadrangular plate shape as a whole by the first region 9 and the second region 11.

At least a part of a ridge line part, which is an intersecting part of the upper surface 3 and the side surface 7, is a cutting edge 13 usable in a cutting process of a workpiece. Specifically, the cutting edge 13 is located in at least a part of the plurality of corner parts and the plurality of side parts in the upper surface 3. However, there is no problem even if the entirety of the plurality of corner parts and the plurality of side parts on the upper surface 3 is the cutting edge 13. Although the cutting edge 13 has a straight line shape of a constant height in a non-limiting aspect of the disclosure, the shape of the cutting edge 13 is not limited thereto. There is no problem even if the cutting edge 13 includes, for example, a curvilinear shaped portion.

A so-called honing process may be applied to a part of the intersecting part of the upper surface 3 and the side surface 7, at which the cutting edge 13 is located. After the application of the honing process, the shape of the intersecting part of the upper surface 3 and the side surface 7 is changed from a strict line shape formed by the intersecting part of the two surfaces, to a slightly curved surface shape. Strength of the cutting edge 13 can be improved by applying the honing process.

The second region 11 includes the cutting edge 13 because the second region 11 is located on the first region 9 in a non-limiting aspect of the disclosure. That is, it can be said that the tip 1 of a non-limiting aspect of the disclosure is composed of the first region 9 and the second region 11 including the cutting edge 13 in at least a part of the ridge line part of the surfaces (the upper surface 3 and the side surface 7) adjacent to each other.

Although the first region 9 and the second region 11 may be joined together with an adhesive, such as a brazing material, the first region 9 and the second region 11 in a non-limiting aspect of the disclosure are fused together and formed integrally.

Specifically, the tip 1 of a non-limiting aspect of the disclosure is formed by overlaying a green body that becomes the first region 9 and a green body that becomes the second region 11, followed by co-sintering. When the first region 9 and the second region 11 are thus formed integrally, joinability of these regions can be enhanced.

Although the integral formation of the first region 9 and the second region 11 leads to the enhanced joinability of these regions, there has been a recent desire to further enhance the joinability of the first region 9 and the second region 11. In the tip 1 of a non-limiting aspect of the disclosure, a boundary surface between the first region 9 and the secondary region 11 includes a curved surface portion 15 being projected from a side of the second region 11 toward a side of the first region 9.

In a cutting process of a workpiece for manufacturing a machined product, a load generated during the cutting process is applied to the cutting edge 13. The load is transmitted through the interior of the tip 1 to the boundary surface between the first region 9 and the second region 11. Because the boundary surface between the first region 9 and the second region 11 includes the curved surface portion 15, the second region 11 is less likely to separate from the first region 9, thus leading to the tip 1 having good joinability.

Specifically, the boundary surface between the first region 9 and the second region 11 is not a simple flat surface but includes the curved surface portion 15. Therefore, even if separation occurs on a part of the boundary surface, the separation is less likely to develop in the curved surface portion 15. Alternatively, a part of the boundary surface between the first region 9 and the second region 11 may be the curved surface portion 15. However, when the entirety of the boundary surface between the first region 9 and the second region 11 is composed of the curved surface portion 15 in a non-limiting aspect of the disclosure, the joinability of the first region 9 and the second region 11 can be enhanced.

In the tip 1 of a non-limiting aspect of the disclosure, the curved surface portion 15 in the boundary surface is projected from a side of the second region 11 toward a side of the first region 9. This makes it possible to increase an angle θ formed by the curved surface portion 15 and an imaginary straight line X extending from the cutting edge 13 toward the curved surface portion 15. Consequently, an angle formed by the curved surface portion 15 and a direction in which the load is transmitted becomes large even when a load generated during the cutting process is applied from the cutting edge 13 to the curved surface portion 15. The load is therefore less likely to be transmitted to the curved surface portion 15, and separation is therefore less likely to occur on the curved surface portion 15.

The curved surface portion 15 in a non-limiting aspect of the disclosure includes a region having a gentle curved surface shape with a great radius of curvature. Specifically, the curved surface portion 15 includes the region whose radius of curvature is greater than a distance L from the cutting edge 13 to the curved surface portion 15 in a cross section that is orthogonal to the cutting edge 13 and includes the curved surface portion 15. More specifically, the curved surface portion 15 includes the region having the gentle curved surface with the great radius of curvature in the cross section that is orthogonal to the cutting edge 13 and includes the curved surface portion 15. In the region, the radius of curvature is greater than the distance L from the cutting edge 13.

The curved surface shape including the region described above helps to avoid that the load being transmitted from the cutting edge 13 to at least this region is concentrated on a part in this region, and the load is dispersible over a wide range in the cutting edge 13. The second region is therefore much less likely to separate from the first region 9.

In particular, with the configuration that the entirety of the curved surface portion 15 includes a greater radius of curvature than the distance L from the cutting edge 13 to the curved surface portion 15 in the cross section that is orthogonal to the cutting edge 13 and includes the curved surface portion 15, the second region 11 is far less likely to separate from the first region 9.

The curved surface portion 15 in a non-limiting aspect of the disclosure also includes a region orthogonal to an imaginary straight line X connecting the cutting edge 13 and the curved surface portion 15 in the cross section that is orthogonal to the cutting edge 13 and includes the curved surface portion 15.

Specifically, the curved surface portion 15 includes the region orthogonal to the imaginary straight line X extending from the cutting edge 13 in the cross section that is orthogonal to the cutting edge 13 and includes the curved surface portion 15.

When the curved surface portion 15 includes the region having the above shape, a crack is much less likely to propagate to at least the region in which the curved surface portion 15 is orthogonal to a straight line connecting the cutting edge 13 and the curved surface portion 15. It is therefore possible to further enhance durability against the above-mentioned load transmitted from the cutting edge 13 to the boundary surface between the first region 9 and the second region 11.

The curved surface portion 15 in a non-limiting aspect of the disclosure also includes an end portion of the boundary surface between the first region 9 and the second region 11. Separation is apt to occur on the end portion of the boundary surface between the first region 9 and the second region 11. When the curved surface portion 15 capable of reducing the occurrence of separation includes the end portion being apt to separate, the second region 11 is much less likely to separate from the first region 9.

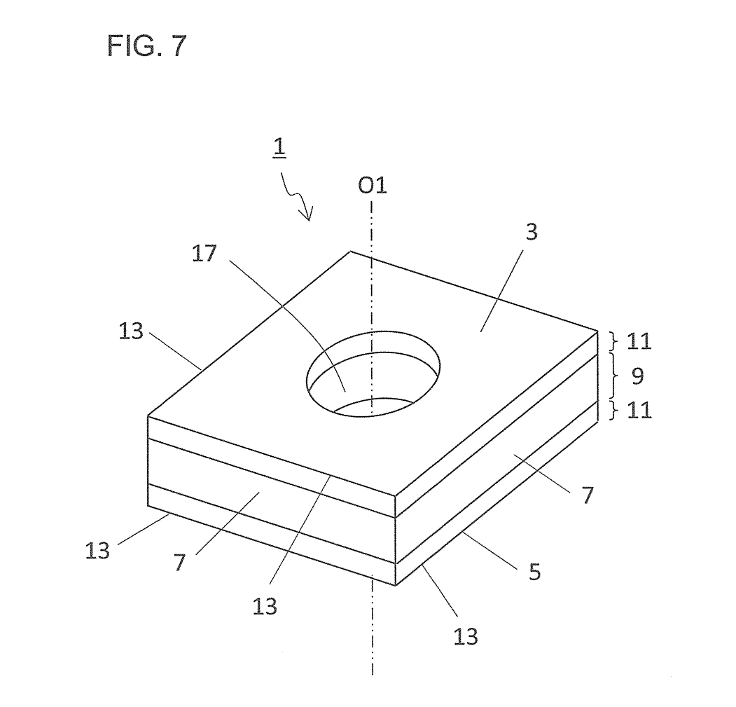

Although the tip 1 of a non-limiting aspect of the disclosure is configured to include the single first region 9 and the single second region 11 each having the quadrangular plate shape, the tip 1 is not limited to this configuration. For example, as illustrated in FIG. 7, the tip 1 may include a single first region 9 having a quadrangular plate shape and two second regions 11 having a quadrangular plate shape, and the first region 9 may be held between the two second regions 11.

When the two second regions 11 include the same thickness in a vertical direction, it is possible to reduce variations in strength of the two second regions 11. Here, the term “the same thickness” needs not be strictly the same, but a deviation of approximately 5% is allowable.

In a first modification illustrated in FIG. 7, the cutting edge 13 is also located in at least a part of a plurality of corner parts and a plurality of side parts in the lower surface 5, in addition to at least a part of a plurality of corner parts and a plurality of side parts in the upper surface 3. The first modification provides the economically excellent tip 1 because of an increase in the region of the cutting edge 13.

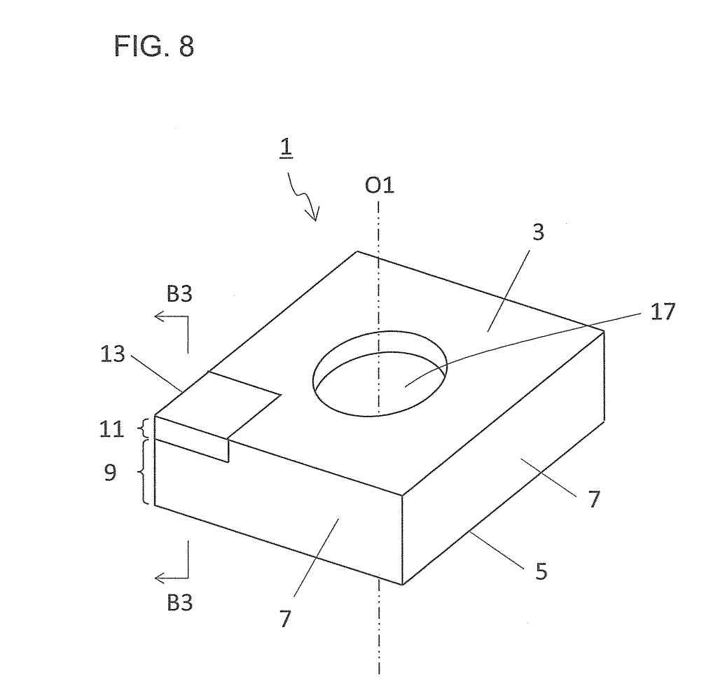

As illustrated in FIG. 8, a single first region 9 and a single second region 11 each having a quadrangular plate shape may be included, and the second region 11 may be a partial region including only a single corner part of the upper surface 3. The second region 11 in the second modification illustrated in FIG. 8 is located on the first region 9 and includes one of four corner parts in the upper surface 3.

Specifically, the first region 9 has an approximately quadrangular plate shape, namely, a shape obtained by cutting out a part of the first region 9 which includes one of the corner parts of the upper surface 3. The second region 11 has a shape corresponding to the cut-out part of the first region 9. Accordingly, the tip 1 has the quadrangular plate shape as a whole by the first region 9 and the second region 11. The second region 11 may have a shape constituting a part of the upper surface 3 as in the case of the second modification. For example, when an inexpensive material is used for the first region 9, this modification provides the tip 1 excellent in manufacturing costs.

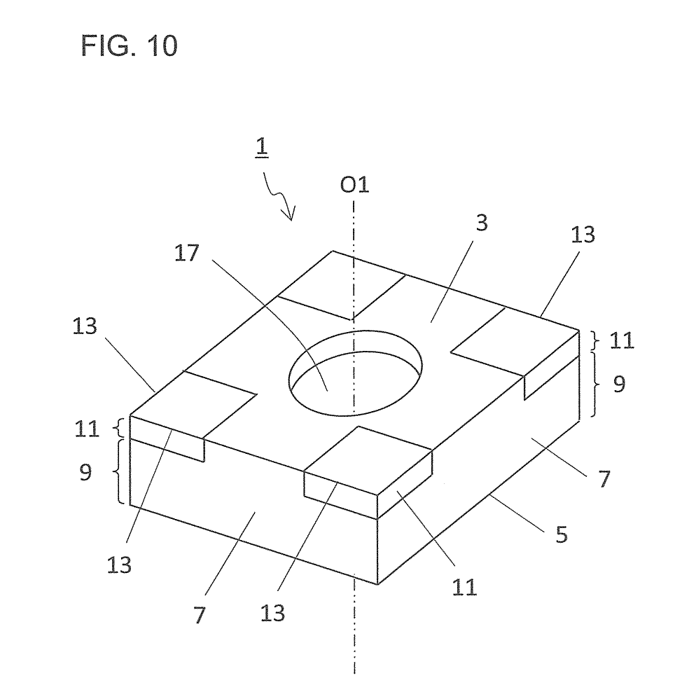

Although the tip 1 of the second modification includes the single second region 11, the tip 1 may include a plurality of second regions 11 as illustrated in FIG. 10. In a third modification illustrated in FIG. 10, the first region 9 has a shape obtained by cutting out four corner parts in the upper surface 3. The second regions 11 are respectively located at four cut-out portions. Accordingly, the tip 1 of the third modification includes the four second regions 11. Similarly to the first modification, the third modification provides the economically excellent tip 1 because of an increase in the region of the cutting edge 13.

The shapes of the upper surface 3 and the lower surface 5 are not limited to those in the foregoing embodiments. The shape of the upper surface 3 in a top view is the approximately quadrangular shape in the tip 1 of a non-limiting aspect of the disclosure. For example, the shape of the upper surface 3 in a top view may be a polygonal shape, such as a triangular shape, a pentagonal shape, or a hexagonal shape. In cases where the shape of the upper surface 3 is a quadrangular shape, the shape of the upper surface 3 can be a rectangle, parallelogram, rhombus, and a square.

The cutting edge 13 is located in at least a part of the intersecting part of the upper surface 3 and the side surface 7. Here, one of the upper surface 3 and the side surface 7 functions as a so-called “rake surface,” and the other functions as a so-called “flank surface.” The upper surface 3 functions as the rake surface, and the side surface 7 functions as the flank surface in a non-limiting aspect of the disclosure. There is no problem even if the side surface 7 functions as the rake surface and the upper surface 3 functions as the flank surface in the tip 1.

A through hole 17 is located so as to extend between a center of the upper surface 3 and a center of the lower surface 5 as illustrated in FIG. 1 and the like. The through hole 17 is provided for the purpose of fixing the tip 1 to a holder of a cutting tool.

Specifically, the through hole 17 is provided for inserting a screw therein when screwing the tip 1 into the holder of the cutting tool. A method of fixing the tip 1 to the holder is not limited to the screwing as described above. For example, the through hole 17 is also usable when fixing the tip 1 to the holder by a clamper or lever.

An axis of the through hole 17 in a non-limiting aspect of the disclosure coincides with a central axis O1 of the tip 1 passing through the center of the upper surface 3 and the center of the lower surface 5. A direction of the axis of the through hole 17 is orthogonal to the upper surface 3 and the lower surface 5. The through hole 17 needs not be located so as to extend between the center of the upper surface 3 and the center of the lower surface 5. For example, the through hole 17 may be located so as to extend between oppositely located regions in the side surface 7.

For example, metal, cemented carbide, or cermet is usable as a material of a member constituting the first region 9. Examples of the metal include stainless steel and titanium. Examples of composition of the cemented carbide include WC(tungsten carbide)-Co(cobalt), WC—TiC(titanium carbide)-Co, and WC—TiC—TaC(tantalum carbide)-Co.

Here, WC, TiC, and TaC are hard particles, and Co is a binder phase. The cermet is a sintered composite material obtained by compositing metal into a ceramic ingredient. A specific example of the cermet is one which is composed mainly of a titanium compound, such as TiC or TiN (titanium nitride).

Examples of material constituting the second region 11 include diamond sintered body, CBN (Cubic Boron Nitride), cemented carbide, and cermet. Examples of usable cemented carbide and cermet include the same ones as described as the material constituting the first region 9.

A material constituting the first region 9 is different from a material constituting the second region 11. For example, because the cutting edge 13 is located in the second region 11, a material having high hardness may be selected as the material of the second region 11 in order to obtain the cutting edge 13 having high strength, and an inexpensive material that is different from the material of the second region 11 may be selected as the material of the first region 9. For example, the first region 9 may be composed mainly of WC, and the second region 11 including the cutting edge 13 may be composed mainly of CBN.

Even when a material as a major ingredient of the first region 9 is different from that of the second region 11, the joinability of the first region 9 and the second region 11 can be enhanced when these two regions contain the same ingredient. For example, each of the first region 9 and the second region 11 may contain WC.

In cases where the first region 9 and the second region 11 contain the same material, the hardness of the second region 11 including the cutting edge 13 may be enhanced by adjusting particle diameters in both regions.

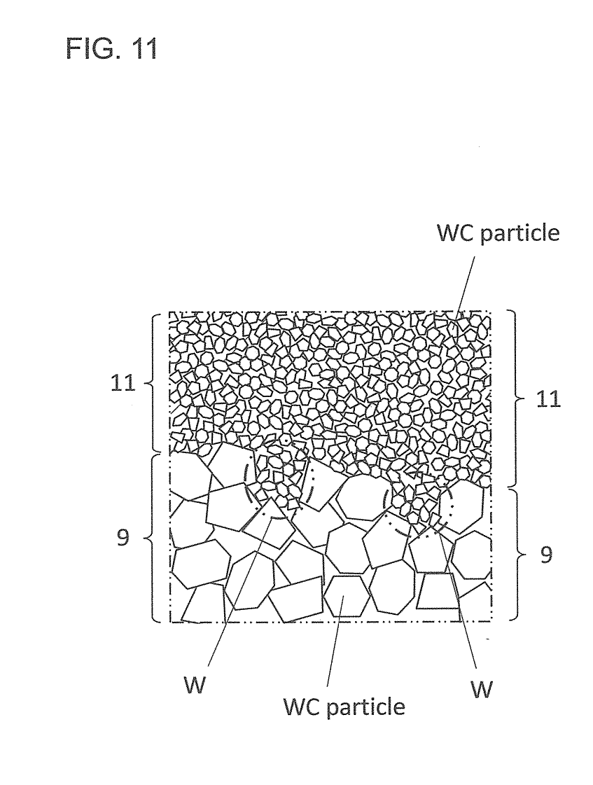

For example, the hardness of the second region 11 including the cutting edge 13 can be enhanced when each of the first region 9 and the second region 11 contains WC, and when a mean particle diameter of WC in the second region 11 is smaller than a mean particle diameter of WC in the first region 9 as illustrated in FIG. 11.

The joinability of the first region 9 and the second region 11 can be further enhanced with such a configuration that WC particles in the second region 11 microscopically get in between WC particles in the first region 11 in the boundary surface between the first region 9 and the second region 11 as illustrated in FIG. 11, in cases where the mean particle diameter of WC in the second region 11 is smaller than the mean particle diameter of WC in the first region 9. This is because the WC particles in the second region 11 perform a role as “wedges W.”

A tip 1 of a second non-limiting embodiment is described below with reference to the drawings. The tip 1 of the second non-limiting embodiment is usable, for example, in a grooving process that is one of turning processes.

Similarly to the tip 1 of the first non-limiting embodiment, the tip 1 of a non-limiting aspect of the disclosure is composed of a first region 9 and a second region 11. The tip 1 of a non-limiting aspect of the disclosure differs from the tip of the first non-limiting embodiment in the following points, which are described in detail below. Descriptions of configurations similar to those in the tip of the first non-limiting embodiment are omitted here.

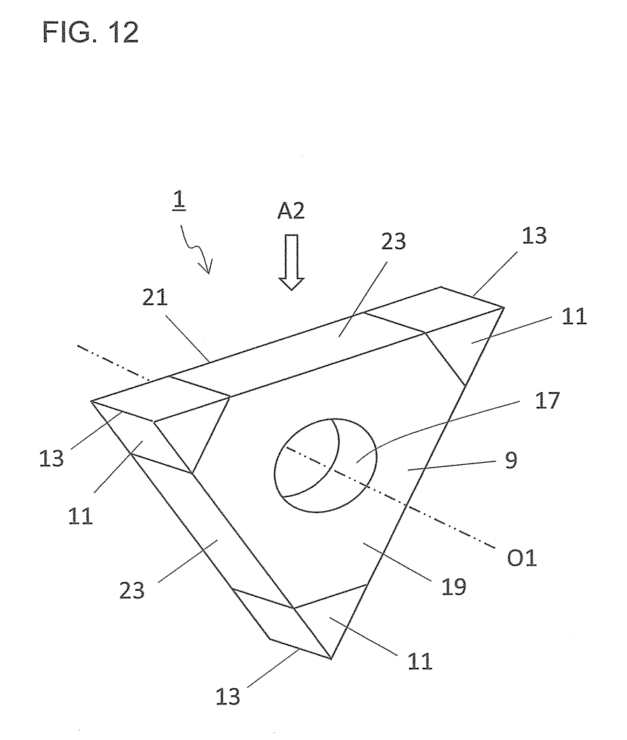

The tip 1 of a non-limiting aspect of the disclosure includes a first surface, a second surface, and a third surface as illustrated in FIG. 12 and the like. Hereinafter, for the sake of convenience, the first surface, the second surface, and the third surface are respectively referred to “a first side surface 19,” “a second side surface 21,” and “an outer peripheral surface 23” in conformity to FIG. 12. The first side surface 19 corresponds to the upper surface 3 in the tip 1 of the first non-limiting embodiment. The second side surface 21 corresponds to the lower surface 5 in the tip 1 of the first non-limiting embodiment. The outer peripheral surface 23 corresponds to the side surface 7 in the tip of the first non-limiting embodiment.

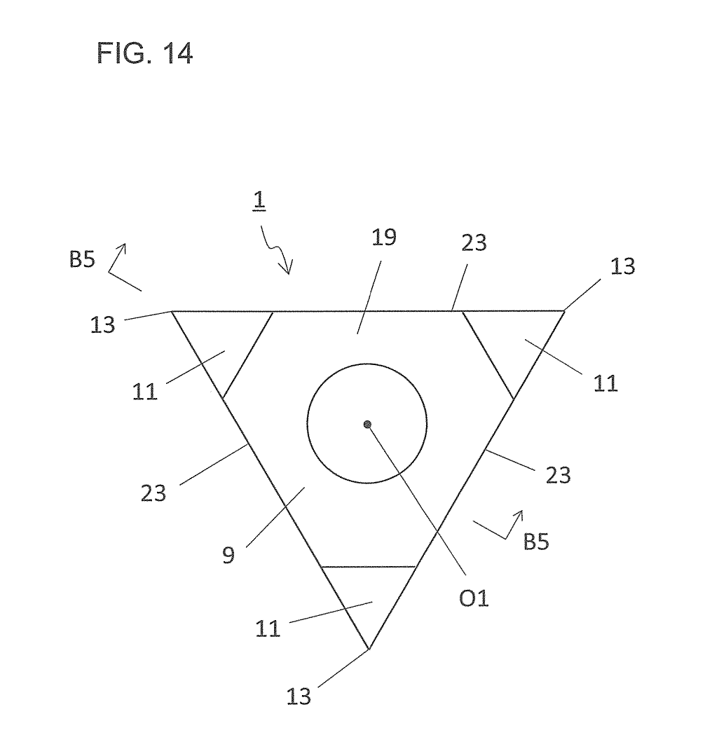

The first side surface 19 has an approximately polygonal shape and includes a plurality of corner parts and a plurality of side parts as illustrated in FIG. 14. The first side surface 19 has an approximately triangular shape and includes three corner parts and three side parts in a non-limiting aspect of the disclosure.

Similarly to the corner parts in the first non-limiting embodiment, the corner parts in another aspect of the disclosure are not limited to strict corners. Similarly to the side parts in the first non-limiting embodiment, the side parts in a further aspect of the disclosure are not limited to strict straight line shaped ones.

The second side surface 21 is a surface located on an opposite side of the first side surface 19, and functions as a seating surface with respect to a pocket when attaching the tip 1 of a non-limiting aspect of the disclosure to a holder. Similarly to the first side surface 19, the second side surface 21 in a non-limiting aspect of the disclosure has an approximately polygonal shape, specifically, an approximately triangular shape. The second side surface 21 in a non-limiting aspect of the disclosure has the same shape as the first side surface 19, and the first side surface 19 is overlapped with the second side surface 21 in a side view.

The outer peripheral surface 23 is a surface adjacent to the first side surface 19 and the second side surface 21. The outer peripheral surface 23 in a non-limiting aspect of the disclosure is located between the first side surface 19 and the second side surface 21, and connects to each of the first side surface 19 and the second side surface 21 as illustrated in FIG. 12. Because each of the first side surface 19 and the second side surface 21 has the triangular shape, the outer peripheral surface 23 is composed of three surface regions. Because the first side surface 19 and the second side surface 21 have the same shape, the outer peripheral surface 23 in the tip 1 illustrated in FIG. 12 is orthogonal to the first side surface 19 and the second side surface 21.

The tip 1 of a non-limiting aspect of the disclosure is composed of a first region 9 and a second region 11, and has a triangular plate shape as a whole. Specifically, the first region 9 has an approximately triangular plate shape, and the second region 11 is located at each of three corners in the first region 9. In other words, the second region 11 in a non-limiting aspect of the disclosure is partially located in a region including the three corners in the tip 1 having the triangular plate shape, and the first region 9 is located in a region other than the second region 11.

The three second regions 19 are 120° rotationally symmetric on the basis of a central axis O1 of the tip 1 in a side view of the first side surface 19. That is, the second regions 19 are located so as to be overlapped with each other when the tip 1 is rotated 120° on the basis of the central axis O1.

The outer peripheral surface 23 is composed of three surface regions. Each of the three surface regions intersects with the surface region adjacent thereto. A cutting edge 13 is located in at least a part of an intersecting part of the two surface regions. There is no problem even if the entirety of the intersecting part of the surface regions is the cutting edge 13.

The second regions 11 respectively include the cutting edges 13 because the second region 11 is located in each of regions including the corner at each of the three corners in the tip 1 having the triangular plate shape in a non-limiting aspect of the disclosure. That is, it can be said that the tip 1 of a non-limiting aspect of the disclosure is composed of the first region 9 and the second regions 11 each including the cutting edge 13 as in the case of the tip 1 of the first non-limiting embodiment. Similarly to the tip 1 of the first non-limiting embodiment, the first region 9 and the second regions 11 are fused together in the tip 1 of a non-limiting aspect of the disclosure.

Similarly to the tip 1 of the first non-limiting embodiment, a boundary surface between the first region 9 and the secondary regions 11 includes a curved surface portion 15 being projected from a side of the second region 11 toward a side of the first region 9 in the tip 1 of a non-limiting aspect of the disclosure. Also in the tip 1 of a non-limiting aspect of the disclosure, the second regions 11 are therefore less likely to separate from the first region 9, thus leading to good joinability.

Although the second regions 11 are respectively located at the three corners in the tip 1 having the triangular plate shape in FIG. 14, there is no intention to limit to this configuration. For example, the second region 11 may be located only at one or two of the corners in the tip 1 having the triangular plate shape.

The shapes of the first side surface 19 and the second side surface 21 are not limited to those in the foregoing embodiments. Although the shape of the first side surface 19 in a side view is the approximately triangular shape in the tip 1 of a non-limiting aspect of the disclosure, the shape of the first side surface 19 may be a polygonal shape, such as a quadrangular shape, a pentagonal shape, or a hexagonal shape.

The cutting edge 13 is located in at least a part of the intersecting part of the surface regions adjacent to each other in the outer peripheral surface 23. Here, one of the two intersecting surface regions functions as a so-called “rake surface,” and the other functions as a so-called “flank surface.”

Although the tips 1 of the plurality of embodiments and the modifications of these tips 1 have been illustrated and described above, the present invention is not limited thereto. It is, of course, possible to make the tips into arbitrary ones insofar as they do not depart from the spirit and scope of the present invention. For example, even though the tip 1 of the first non-limiting embodiment and the tip 1 of the second non-limiting embodiment are usable in the turning processes, both may be tips usable in milling processes.

<Cutting Tool>

A cutting tool 101 in a non-limiting aspect of the disclosure is described below with reference to the drawings.

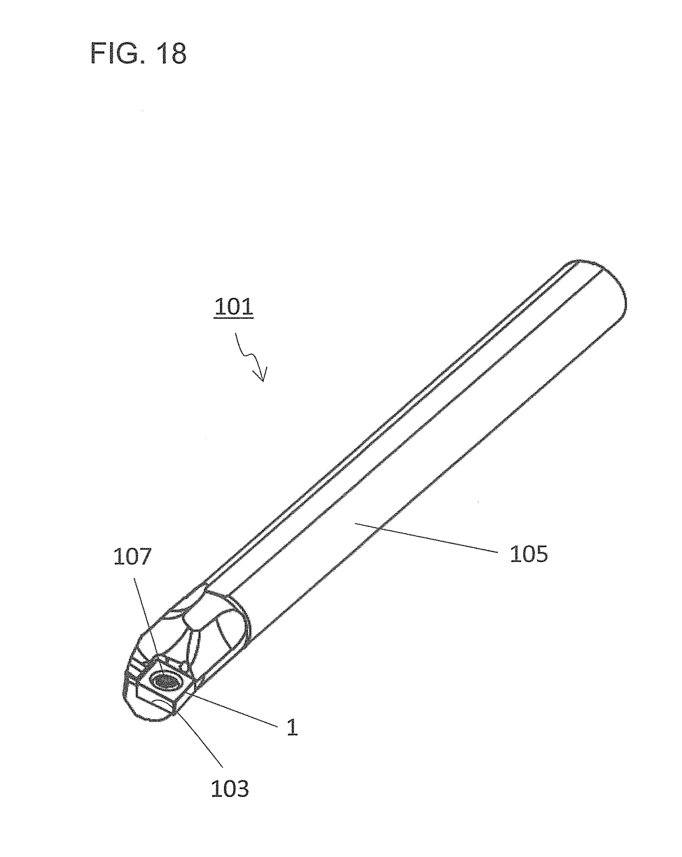

As illustrated in FIG. 18, the cutting tool 101 in an aspect of the disclosure includes a holder 105 including a pocket 103 at a side of a front end thereof, and the tip 1 located at the pocket 103. The cutting tool 101 in an aspect of the disclosure includes the tip 1 of the first non-limiting embodiment. A part of the tip 1 which is usable as a cutting edge protrudes from the front end of the holder 105.

The holder 105 is a bar-shaped body that extends long and narrow. The single pocket 103 is disposed at the side of the front end of the holder 105. The pocket 103 is a portion to which the tip 1 is attached, and which opens into a front end surface of the holder 105. The attachment of the tip 1 is facilitated because the pocket 103 also opens into a side surface of the holder 105. Specifically, the pocket 103 includes a seating surface (not illustrated) brought into contact with the lower surface of the tip 1, and a constraining side surface (not illustrated) orthogonal to the seating surface.

The tip 1 is located at the pocket 103. The lower surface of the tip 1 may be directly contacted with the pocket 103. Alternatively, a sheet may be held between the tip 1 and the pocket 103.

The tip 1 is attached so that at least a part of the cutting edge protrudes outward from the holder 105. The tip 1 is attached to the holder 105 by a fixing screw 107 in an aspect of the disclosure. Specifically, screw portions are screwed together by inserting the fixing screw 107 into the through hole of the tip 1, and by inserting a front end of the fixing screw 107 into a screw hole (not illustrated) formed in the pocket 103. Thus, the tip 1 is attached to the holder 105.

As a material of the holder 105, for example, steel or cast iron is usable. Of these materials, high rigidity steel may be used in a non-limiting aspect of the disclosure.

Aspects of the disclosure illustrate and describe the cutting tool used in a so-called outer diameter machining. The outer diameter machining is one kind of turning processes. The cutting tool is not limited to one which is usable in the outer diameter machining. For example, the tips 1 of the foregoing embodiments may be used for cutting tools usable in an inner diameter machining that is one kind of turning processes, and a grooving process. Alternatively, the tips 1 of the foregoing embodiments may be applied to cutting tools usable in the milling process.

<Method of Manufacturing Machined Product>

A method of manufacturing a machined product in a non-limiting aspect of the disclosure of the present invention is described below with reference to the drawings.

The machined product is manufacturable by carrying out a cutting process of a workpiece 201. The method of manufacturing a machined product in an aspect of the disclosure includes the following steps:

(1) rotating the workpiece 201;

(2) bringing the cutting tool 101 represented by the above aspects of the disclosure into contact with the workpiece 201 being rotated; and

(3) moving the cutting tool 101 away from the workpiece 201.

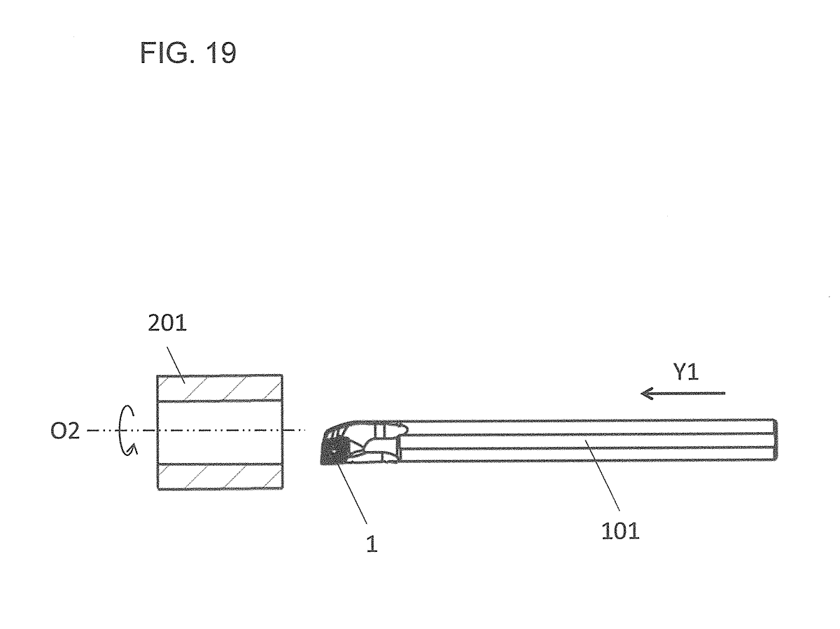

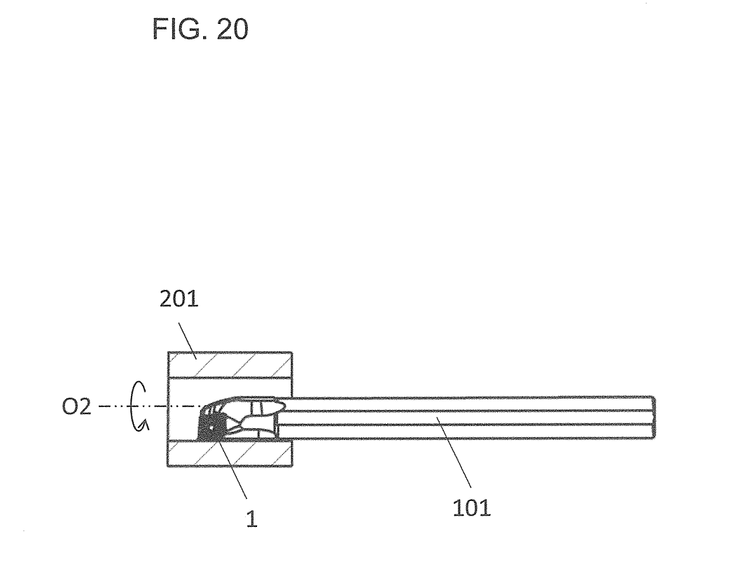

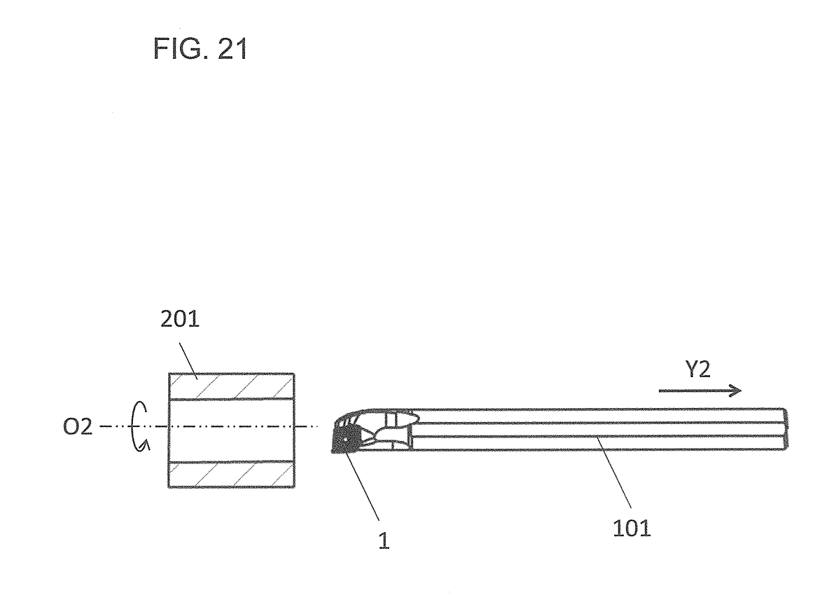

More specifically, firstly, the workpiece 201 is rotated around an axis O2, and the cutting tool 101 is relatively brought near the workpiece 201 as illustrated in FIG. 19. Then, the workpiece 201 is cut out by bringing the ridge line part (cutting edge) in the cutting tool 101 into contact with the workpiece 201 as illustrated in FIG. 20. Thereafter, the cutting tool 101 is relatively moved away from the workpiece 201 as illustrated in FIG. 21.

In an aspect of the disclosure, the cutting tool 101 is brought near the workpiece 201 by fixing the axis O2, and by moving the cutting tool 101 in Y1 direction in a state in which the workpiece 201 is rotated around the axis O2. In FIG. 20, the workpiece 201 is cut out by bringing the cutting edge in the tip 1 into contact with the workpiece 201 being rotated. In FIG. 21, the cutting tool 101 is moved away by being moved in Y2 direction in a state in which the workpiece 201 is rotated.

During the cutting process with the manufacturing method of an aspect of the disclosure, the cutting tool 101 is brought into contact with the workpiece 201, or the cutting tool 101 is moved away from the workpiece 201 by moving the cutting tool 101 in each of the steps. However, there is no intention to limit to the above embodiments.

For example, the workpiece 201 may be brought near the cutting tool 101 in the step (1). Similarly, the workpiece 201 may be moved away from the cutting tool 101 in the step (3). When the cutting process is continued, it is necessary to repeat the step of bringing the cutting edge in the tip 1 into contact with different portions of the workpiece 201, while keeping the workpiece 201 rotated.

Representative examples of material of the workpiece 201 include carbon steel, alloy steel, stainless steel, cast iron, and nonferrous metals.

Additional advantages and modifications will readily occur to those skilled in the art. Therefore, the invention in its broader aspects is not limited to the specific details and representative embodiments shown and described herein. One skilled in the art would recognize that various features in the disclosure are not necessarily mutually exclusive, as some aspects of the disclosure may be combined with one or more other embodiments and aspects of the disclosure. Accordingly, various modifications may be made without departing from the spirit or scope of the general inventive concept as defined by the appended claims and their equivalents.

### DESCRIPTION OF THE REFERENCE NUMERALS

1 tip
3 upper surface
5 lower surface
7 side surface
9 first region
11 second region
13 cutting edge
15 curved surface portion
17 through hole
19 first side surface
21 second side surface
23 outer peripheral surface
101 cutting tool
103 pocket
105 holder
107 fixing screw
201 workpiece

1. A cutting tool tip, comprising:
a first region; and
a second region which differs from the first region in material and comprises a cutting edge in at least a part of a ridge line part of surfaces adjacent to each other, wherein
a boundary surface between the first region and the second region comprises a curved surface portion being projected from a side of the second region toward a side of the first region.

2. The cutting tool tip according to claim 1, wherein
the curved surface portion comprises a region whose radius of curvature is greater than a distance from the cutting edge to the curved surface portion in a cross section which is orthogonal to the cutting edge and includes the curved surface portion.

3. The cutting tool tip according to claim 1, wherein
the curved surface portion comprises a region orthogonal to a straight line connecting the cutting edge and the curved surface portion in a cross section which is orthogonal to the cutting edge and includes the curved surface portion.

4. The cutting tool tip according to claim 1, wherein
the curved surface portion comprises an end portion of the boundary surface.

5. The cutting tool tip according to claim 1, wherein
the first region comprises tungsten carbide, and the second region comprises cubic boron nitride.

6. The cutting tool tip according to claim 1, wherein
the first region comprises tungsten carbide, and the second region comprises tungsten carbide.

7. The cutting tool tip according to claim 6, wherein
a mean particle diameter of tungsten carbide particles in the second region is smaller than a mean particle diameter of tungsten carbide particles in the first region.

8. A cutting tool, comprising:
a holder comprising a pocket at a side of a front end of the holder; and
the cutting tool tip according to claim 1 which is located at the pocket in the holder.

9. A method of manufacturing a machined product, comprising:
rotating a workpiece;
bringing the cutting tool according to claim 8 into contact with the workpiece being rotated; and
moving the cutting tool away from the workpiece.
